(19) United States
(12) Patent Application Publication
(10) Pub. No.: US 2025/0102347 A1
(43) Pub. Date: Mar. 27, 2025

(54) VIBRONIC MEASURING DEVICE AND METHOD FOR SIGNAL PROCESSING IN SUCH A MEASURING DEVICE

(71) Applicant: VEGA Grieshaber KG, Wolfach (DE)

(72) Inventors: Matthias Wöhrle, Gutach (DE); Benjamin Schätzle, Schuttertal (DE)

(21) Appl. No.: 18/888,235

(22) Filed: Sep. 18, 2024

(30) Foreign Application Priority Data
Sep. 21, 2023 (DE) 10 2023 125 689.0

(51) Int. Cl. G01F 25/20; G01F 23/296

(52) U.S. Cl. CPC G01F 25/24; G01F 23/2968

(57) ABSTRACT

A vibronic measuring device, e.g. limit level sensor, for determining and/or monitoring at least one process variable, includes a mechanically oscillatory unit, which is excited to vibrate by at least one drive unit based on an electrical signal S_{A}. A receiving unit receives and converts mechanical vibrations into an electrical signal S_{E}. A control and evaluation unit applies closed- and/or open-loop control of the vibrational excitation, and evaluates the signal S_{E} with respect to the process variable. A vibration sensor pick up a sensor signal S_{S} at the vibration sensor, and an analysis unit is supplied with signals S_{E} and S_{S}, and applies self-learning analysis of the input signals and transmits reliability information for the signal S_{E} to the control and evaluation unit.

### RELATED APPLICATION

This Application claims priority from Application 10 2023 125 689.0 filed on Sep. 21, 2023, in Germany. The entire contents of the priority application is incorporated herein by reference in its entirety.

Vibration sensors, also termed vibronic sensors or vibration limit level sensors, having piezoelectric transmitting and/or receiving devices are known from the prior art. Piezoelectric transmitting and/or receiving devices are used in vibration sensors, which are often used in fill level measurement technology as limit level sensors, as a transmitting and/or receiving device. Often, such piezoelectric transmitting and/or receiving devices are also termed a drive.

### BACKGROUND OF THE INVENTION

Vibration sensors according to the present application, particularly vibration limit level switches for liquids and bulk goods, operate according to the principle of resonant frequency shift and/or throw out a vibrational amplitude. The vibration sensor vibrates with a different resonant frequency and amplitude depending on covered state, density and temperature of the medium. The amplitude of the resonant frequency depends in this case on the viscosity of the medium. The frequency shift depends on the density and temperature of the medium. For fill level monitoring, such sensors are installed in containers at the height of a fill level that is to be monitored and emit a piece of status information on the basis of the preceding parameters. Actually, information can be picked up at the sensors about whether the sensor is covered or uncovered, or whether a fill level of the medium has reached the fill level to be monitored (covered) or fallen below the fill level to be monitored (uncovered).

Typically, the vibration sensor has a membrane which can be excited to vibrate by means of such a drive, by means of which membrane a mechanical oscillator arranged on the membrane as a mechanical oscillatory unit can be excited to vibrate. Depending on a covered state of the mechanical oscillator with a filling material and depending on the viscosity of this filling material, the mechanical oscillator vibrates with a characteristic frequency which is detected by the vibration sensor and can be converted into a measurement signal.

DE 10 2012 101 667 A1 relates to a vibronic measuring device for determining and/or monitoring at least one process variable of a medium in a container, having at least one mechanically oscillatory unit, having at least one piezoelectric drive and receiving unit for exciting the mechanically oscillatory unit to vibrate mechanically by means of an electrical excitation signal and for receiving and converting mechanical vibrations into an electrical receiving signal, and having at least one control and evaluation unit for closed-loop control and/or open-loop control of the vibrational excitation and for evaluation of the receiving signal with respect to the process variable. The process variable is for example the fill level, particularly a limit level, the density, the viscosity or the flow of a liquid medium, or the fill level of a bulk material. The control and evaluation unit according to the disclosure in DE 10 2012 101 667 A1 is configured, in the event of the presence of at least one extraneous vibration, to control the vibrational excitation in such a manner as a function of the frequency and/or the amplitude of the extraneous vibration that the receiving signal is substantially undisturbed by the extraneous vibration and/or to suppress at least one frequency of an extraneous vibration in the receiving signal.

At the previously mentioned measuring device, according to one embodiment of the method, the extraneous vibration is detected in that the excitation of the mechanically oscillatory unit to vibrate is interrupted and the receiving signal is evaluated during the interruption. This is discovered to be disadvantageous, as a continuous measurement is not possible in this manner.

In an alternative embodiment of the method, the extraneous vibration is detected by means of a vibration sensor which is arranged on the container, in or on the measuring device, or on a component that is connected to the container. Preferably, the vibration sensor is fastened to the process connection of the measuring device.

In principle, the second alternative represents an improved embodiment, as such an interruption of the measurement can be avoided. The reliability and safety of the detection of an extraneous vibration using this system is however considered, as before, to be unsatisfactory.

Extraneous vibrations which are close to the frequency of the fundamental mode of the excitation signal and/or the desired signal of the vibronic measuring device cannot be reliably detected in this manner.

Furthermore, the proposed solution to control the vibrational excitation by changing the excitation frequency such that the receiving signal is substantially undisturbed by the extraneous vibration is technically difficult to implement, as the resonant frequency of the mechanically oscillatory unit depends on its geometry and the medium surrounding the unit and cannot be changed by a change of the excitation. Although the excitation of higher vibrational modes is possible, in the case of an extraneous vibration at or close to the resonant frequency of the dominant mode, the amplitude of these higher vibrational modes is so small that in practice a signal evaluation is not possible or is only possible to an unsatisfactory extent.

### SUMMARY OF THE INVENTION

It is the object of the present invention to provide a vibronic measuring device and a method for signal processing in a vibronic measuring device, which enables improved signal processing, particularly detection and preferably suppression of extraneous vibrations.

A vibronic measuring device according to the invention for determining and/or monitoring at least one process variable of a medium in a container, having at least one mechanically oscillatory unit, having at least one drive and receiving unit for exciting the mechanically oscillatory unit to vibrate mechanically by means of an electrical excitation signal and for receiving and converting mechanical vibrations into an electrical receiving signal, has at least one control and evaluation unit for closed-loop control and/or open-loop control of the vibrational excitation and for evaluation of the receiving signal with respect to the process variable. The vibronic measuring device further has at least one vibration sensor which is coupled with the vibronic measuring device in such a manner that vibrations are transmitted from the measuring device to the vibration sensor, it being possible to pick up a sensor signal at the vibration sensor. According to the invention, the vibronic measuring device has an analysis unit which is connected to the control and evaluation unit, wherein the electrical receiving signal and the sensor signal are supplied to the analysis unit as input signals, the analysis unit is designed as a unit for self-learning analysis of the input signals supplied to it and wherein the analysis unit transmits at least one piece of reliability information for the electrical receiving signal to the control and evaluation unit.

The vibronic measuring device according to the invention is therefore made capable of analysing the input signals supplied to it, in the present case at least the receiving signal of the drive and evaluation unit and the sensor signal of the vibration sensor, and to generate a piece of reliability information for the receiving signal in a self-learning manner. This piece of reliability information may in particular contain a statement about whether or to what extent information about the process variable, which is extracted from the receiving signal by the control and evaluation unit, is to be considered as reliable.

The vibronic measuring device is to this end enabled by the analysis unit, which is preferably designed as an AI unit which is trained by means of suitable training data. The AI unit can preferably be designed as an artificial neural network, to which various input data are supplied, depending on the embodiment of the present invention, wherein a statement about the reliability of the input data is determined on the basis of these input data.

The artificial neural network can for example be designed as a multilayer perceptron, i.e. feedforward neural network.

Vibration sensors according to the present invention can be vibration sensors, acceleration sensors and also inertial measuring units. To detect the six possible kinematic degrees of freedom, an inertial measuring unit has three acceleration sensors (translation sensors), which are orthogonal to one another in each case, for detecting the translational motion in the x, y and z direction and also three angular rate sensors (gyroscopic sensors), which are orientated orthogonally to one another, for detecting rotational movements about the x, y or z axis.

Both the drive and receiving unit and the acceleration sensor are loaded with a superposition of vibrations which result from the measurement itself, that is to say the vibration that is caused by the drive unit in the mechanically oscillatory unit, and extraneous vibrations which are coupled onto the vibronic measuring device via the container for example. The receiving unit “sees” this superposition however due to the mechanical filter of the mechanically oscillatory unit and can therefore detect a direction of the resulting vibration only to a limited extent. The vibration sensor by contrast can pick up the vibration unfiltered and therefore derive additional pieces of information.

Systems are preferred, which can measure the direction, the magnitude and the frequency of accelerations acting on the sensor, so that as many pieces of information as possible are obtained about possible extraneous vibrations which may influence a measurement. The vibration sensor can for example be built as a three-axis accelerometer or as a gyroscope in MEMS technology. Due to the additional pieces of information about the direction and the magnitude of the acceleration, it is possible to classify and evaluate extraneous vibrations better.

The analysis unit according to the present invention is configured such that the analysis of the input signals of the analysis unit takes place inside the vibronic measuring device, so that there is no dependence on a connection to the cloud, i.e. particularly on a network connection. Further advantages of signal processing directly in the measuring device consist for example in a shorter reaction time and simpler ensuring of data protection, as the raw data do not leave the measuring device.

In a preferred embodiment, the electrical receiving signal and/or the sensor signal are supplied to the analysis unit in the time domain and in the spectral domain. This means that either the receiving signal or the sensor signal or the receiving signal and the sensor signal are supplied to the analysis unit both in the time domain and in the spectral domain, i.e. after a spectral analysis. Depending on the desired information, this may be determined better from the signals in the time domain or else in the spectral domain. Time sequences can for example be detected better in the time domain, different frequency components of the signals by contrast can be detected better in the spectral domain.

The transfer of the signals from the time domain to the spectral domain takes place by means of a spectral analysis. Fourier transform and in particular fast Fourier transform (FFT) has become established as the usual algorithm for this.

As a further relevant signal, a temperature signal can be supplied to the analysis unit as input signal. The temperature has a significant influence on the natural frequency of the mechanically oscillatory unit and can be determined without large outlay. Many vibronic measuring devices therefore already have a temperature sensor or a different type of temperature determination, so that the temperature can also be used in the continuing signal processing in the analysis unit.

Optionally, the electrical excitation signal can further be supplied to the analysis unit as input signal. Also, the electrical excitation signal can be supplied in the time domain and/or in the spectral domain.

The analysis unit can be designed for detecting periodic events. Different AI units exist which are particularly well suited for different tasks owing to the algorithms used and/or owing to the fundamental architecture of the AI. Temporally recurring patterns can for example be detected particularly well by what are known as “recurrent neural networks” or “RNNs”. An AI structured in this manner can for example detect periodically recurring events which disrupt or influence a measurement and thus e.g. positively influence the measurement system. If, for example, the system detects that a filling process by means of a pump, which is then running, and a flow of inflowing medium regularly disrupts the measurement, then a measurement can be carried out directly prior to the filling process for example, so that another unaffected measurement value can be determined.

In an additional or alternative embodiment, the analysis unit is suitably designed in particular for detecting frequency patterns. Complex patterns or structures can be detected particularly well here by convolutional neural networks (CNNs). One embodiment for detecting frequency patterns can take place by means of a convolutional neural network which is constructed instead of or in addition to other AI units or inside an AI unit as an additional or alternative neural network.

Analysing frequency patterns creates the possibility of detecting causes of extraneous vibrations. On the basis of the detection of the causes, suitable measures can be taken to reduce an influence of the extraneous vibrations on the measurement result, i.e. in particular a switching decision of the vibronic sensor. Suitable measures for reducing the influence of extraneous vibrations may for example be adjusting the signal filtering, increasing the excitation amplitude or changing the excitation frequency in such a manner that a different normal mode of the mechanically oscillatory unit is excited. Additionally or alternatively, the changing of a switching delay may have a positive influence. Sporadic erroneous results can be suppressed in this manner. Adjusting the filtering may for example also comprise interposing an additional filter. For example, it may be expedient in certain situations to calculate a sliding average over a predeterminable number of measurement values. By means of such averaging, it is likewise possible to suppress individual outliers in the measurement values.

The analysis unit can further be suitably designed to generate and output a warning signal based on the analysis if a quality of the desired signal is too low and therefore the likelihood of misinterpretation is too high. In this manner, the input signal can be discarded in certain situations, so that errors are avoided. In particular, if measures for reducing the influence of the extraneous vibrations on the desired signal are exhausted, it may be expedient to output such a warning message. The warning message can be output additionally or alternatively to the output signal. The output signal obtained can therefore be discarded and instead a warning signal can be output or a warning, which identifies the output signal as unreliable, is output in addition to the output signal.

In a further development, the analysis unit of the control and evaluation unit can transmit an adjustment signal for adjusting at least one adaptive filter for the receiving signal. This may be expedient in particular if a source of extraneous vibrations can be identified and generates characteristic frequencies which can be filtered well.

In one variant, the analysis unit is designed in such a manner that it detects and classifies events which cause extraneous vibrations and provides a classifier to the control and evaluation unit, which identifies the respective class of the detected event. Such a classification can in this case help to determine countermeasures for various classes of events, wherein the events of a class have the same or at least similar properties.

The control and evaluation unit can for example be designed in such a manner that it adjusts a measuring rate and/or signal processing, particularly filtering, on the basis of the classification. Various possibilities for this have already been described above.

A method according to the invention for signal processing in a vibronic measuring device according to the previous description is distinguished in that the electrical receiving signal and the sensor signal are supplied to the analysis unit as input signal and the analysis unit transmits at least one piece of reliability information for the electrical receiving signal to the control and evaluation unit, wherein the analysis unit analyses the input signals that are supplied to it in a self-learning manner.

In a further development of the method, the electrical receiving signal and/or the sensor signal are supplied to the analysis unit in the time domain and in the spectral domain.

In addition, a temperature signal can be supplied to the analysis unit as a further input signal.

In one embodiment of the method, the analysis unit carries out a detection of periodic events.

In a further embodiment of the method, the analysis unit additionally or alternatively carries out a detection of frequency patterns.

It is preferred if the analysis unit generates and outputs a warning signal based on the analysis, particularly if a quality of the desired signal is too low.

In one embodiment, the analysis unit forwards a signal for adjusting at least one adaptive filter for the receiving signal to the control and evaluation unit. By means of this signal, an optimum adjustment of the adaptive filter is achieved, so the desired signal can be extracted from the receiving signal better.

In a further embodiment, the analysis unit detects and classifies events causing extraneous vibrations and outputs a piece of information about this. For example, a classifier, i.e. a value identifying the class of the detected event, may be output. The classifier can then be processed further by the control and evaluation unit and/or a preset of the adaptive filter can be used for filtering the receiving signal.

The control and evaluation unit can further adjust a measuring rate and/or signal processing, particularly filtering, on the basis of the classification and/or the type of an event.

### BRIEF DESCRIPTION OF THE DRAWINGS

The present invention is explained in more detail in the following with reference to the attached figures. In the figures:

FIG. 1 shows a measuring arrangement having a vibronic measuring device, which is designed as a limit level sensor, according to the prior art,

FIG. 2 shows an exemplary embodiment of a vibronic measuring device, which is designed as a limit level sensor, according to the present application, and

FIG. 3 shows an exemplary embodiment of an analysis unit as may be used in the limit level sensor according to FIG. 2.

### DETAILED DESCRIPTION OF THE DRAWINGS

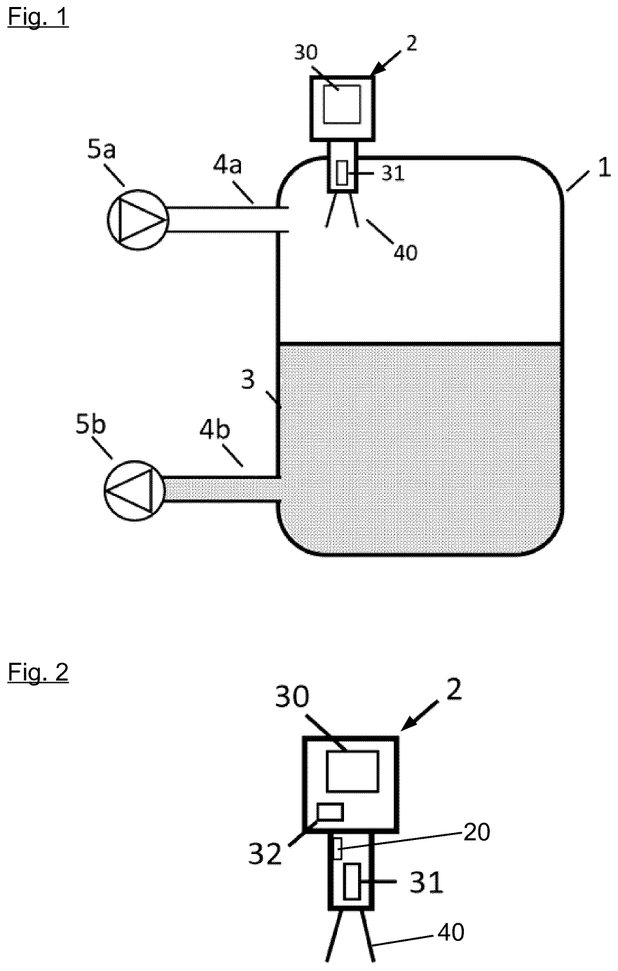

FIG. 1 shows a typical use case of a vibronic measuring device 2 as limit level sensor 2 according to the prior art.

The limit level sensor 2 is installed in a tank 1 as overfill protection. Filling the tank 1 by means of an inlet 4a, which is arranged in an upper region of the tank 1, is effected by means of a pump 5a and is controlled by means of the limit level sensor 2. If the limit level sensor 2 detects a medium 3, then the pump 5a is switched off in order to prevent an overflow of the tank 1. The limit level sensor 2 here uses a piezoelectric drive as electromechanical transducer, which acts as drive and receiving device 31. Alternatively, electromagnetic transducer units are also possible. By means of the electromechanical transducer, a mechanically oscillatory unit 40 is excited at its resonant frequency. By means of the resonant frequency and the amplitude of the vibration, the sensor can detect the presence of a medium 3.

Emptying of the tank 1 takes place by means of an outlet 4b, which is arranged in a lower region, close to a bottom of the tank 1, and is effected by means of a second pump 5b.

If vibrations of the pump 5a are transmitted to the limit level sensor 2, it may come to pass in unfavourable cases that the limit level sensor 2 senses these vibrations as a measurement signal. This may result in a malfunction of the limit level sensor 2. If the vibrations of the pump 5a are located in a region which the limit level sensor 2 would detect as covered, an incorrect switching signal may be output. If the vibrations are located in a region which the limit level sensor 2 would detect as uncovered, exceeding of the limit level may not be detected, which in the worst case has overfilling of the tank 1 as a consequence.

FIG. 2 shows a limit level sensor 2 according to the present application.

An analysis unit 32 is integrated in the limit level sensor 2, which can detect extraneous vibrations. The analysis unit 32 is coupled with a vibration sensor 20 which is designed as an inertial sensor in the present exemplary embodiment. The vibration sensor 20 is arranged in the limit level sensor 2 in such a manner that it is on the one hand mechanically decoupled from the mechanically oscillatory unit 40, but on the other hand mechanically coupled with a housing of the limit level sensor 2 in such a manner that extraneous vibrations acting on the limit level sensor 2 can be detected as well as possible. The vibration sensor 20 is ideally arranged in the region of a process connection 35 of the limit level sensor 2, so that to the greatest extent possible, only the extraneous vibrations which act on the limit level sensor 2 are evaluated by the vibration sensor 20. Without mechanical decoupling, the vibrations of the mechanically oscillatory unit 40, which are generated by the drive unit 31, cannot be distinguished from extraneous vibrations.

Mechanical decoupling is already achieved if the mechanical vibrations generated by the drive unit 31 for the measurement are present at the vibration sensor 20 to a considerably reduced extent, particularly with an amplitude reduced by a factor of 5, preferably by a factor of 10. A complete mechanical decoupling is not possible however, owing to the arrangement in the same housing.

Further processing of the output signals of the analysis unit 32 takes place in the control and evaluation unit 30. The analysis unit 32 can also be integrated into the control and evaluation unit 30.

A function of the analysis unit 32 is assisted by integrated artificial intelligence in the present case. In this case, various functions can be realized for improving, stabilizing or adjusting the measurement function of the control and evaluation unit 30.

In the present exemplary embodiment, the electrical receiving signal S_{E}, the sensor signal S_{S} and the electrical excitation signal S_{A} are supplied as input signals to the analysis unit 32 in each case in the time domain and also, following a fast Fourier transform, in the spectral domain. A temperature signal T of a temperature sensor, which is arranged adjacent to the mechanically oscillatory unit 40, is supplied to the analysis unit 32 as further input signal.

As output signal, the analysis unit 32 provides a piece of reliability information Z, which identifies a quality and reliability of the receiving signal S_{E}, filter parameters for adjusting an adaptive filter and also a piece of information about regularity of a fault due to extraneous vibrations.

Depending on the piece of reliability information Z, the receiving signal is identified as valid or unreliable by the control and evaluation unit 30. The adjustment of the adaptive filter enables improvement of the piece of reliability information Z. Due to the piece of information about regularity of the fault due to extraneous vibrations, it is possible in the case of regularly recurring faults for a countermeasure to be taken in advance of the fault already, for example an increase of the measuring rate can be carried out, the filter setting can be adjusted and/or influencing of the natural vibration by the extraneous vibration can be reduced, for example by increasing an amplitude of the excitation signal S_{A} or exciting a less influenced or uninfluenced natural vibration of the mechanically oscillatory unit 40.

Further functions are also conceivable. If the pump 5a is not in operation permanently, but rather only sporadically, this can be detected by the AI. If the vibration of the pump 5a is detected, then the measuring rate of the limit level sensor 2 can be increased after that, in order thereby to detect reaching of a maximum fill level more reliably and faster. In an alternative embodiment, it would also be conceivable that measurement and pump 5a are controlled by a common control unit. In this scenario, the operating times of pump and measurement can alternate. Thus, it is possible to check by means of the sensor, in a pause of the pumping process, whether pumping further is permitted.

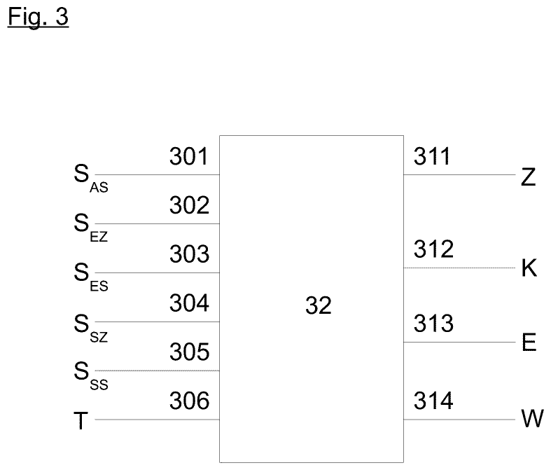

FIG. 3 shows an exemplary embodiment of an analysis unit 32 as may be used in the limit level sensor 2 according to FIG. 2.

The analysis unit 32 according to FIG. 3 in the simplified illustration shown in FIG. 3 has six signal inputs 301-306 and four signal outputs 311-314.

At the first signal input 301, the excitation signal S_{A} is supplied to the analysis unit 32 in the spectral domain S_{AS}. At the second and third signal inputs 302, 303, the receiving signal SE is applied in the time domain S_{EZ} and in the spectral domain S_{ES}. At the fourth and fifth signal inputs 304, 305, the sensor signal S_{S} is applied in the time and in the spectral domain S_{SZ}, S_{SS}. At the sixth signal input 306, the temperature signal T of the temperature sensor is applied.

At the first signal output 301, the piece of reliability information Z can be picked up. At the second signal output 302, a classifier K for extraneous vibrations can be picked up. At the third signal output 303, an adjustment signal E for adjusting the adaptive filter can be picked up, and at the fourth signal output 304, a warning signal can be picked up, which in addition to the piece of reliability information Z represents a warning if the quality of the input signal compared to extraneous vibrations decreases below a threshold value. for example in the sense of a signal to noise ratio.

### REFERENCE LIST

1 Container, tank
2 Vibronic measuring device/limit level sensor
3 Medium
4a Inlet
4b Outlet
5a Pump
5b Pump
20 Vibration sensor
30 Control and evaluation unit
31 Drive and receiving unit
32 Analysis unit
Mechanically oscillatory unit
301-306 Signal inputs
311-314 Signal outputs
E Adjustment signal
K Classifier
S_{A} Excitation signal
S_{E} Receiving signal
S_{S} Sensor signal
T Temperature signal
W Warning signal
Z Piece of reliability information

1. A vibronic measuring device, particularly a limit level sensor, for determining and/or monitoring at least one process variable of a medium in a container, having comprising
at least one mechanically oscillatory unit,
at least one drive and receiving unit for exciting the mechanically oscillatory unit to vibrate mechanically by means of an electrical excitation signal S_{A} and for receiving and converting mechanical vibrations into an electrical receiving signal (S_{E}), and
at least one control and evaluation unit for closed-loop control and/or open-loop control of the vibrational excitation and for evaluation of the receiving signal S_{E} with respect to the process variable,
wherein the vibronic measuring device comprises at least one vibration sensor is coupled with the vibronic measuring device in such a manner that vibrations are transmitted from the measuring device to the vibration sensor to pick up a sensor signal at the vibration sensor,
wherein the vibronic measuring device comprises an analysis unit connected to the control and evaluation unit,
wherein the electrical receiving signal (S_{E}) and the sensor signal (S_{S}) are supplied to the analysis unit as input signals,
wherein the analysis unit performs self-learning analysis of the input signals supplied to it, and
wherein the analysis unit transmits at least one piece of reliability information for the electrical receiving signal (S_{E}) to the control and evaluation unit.

2. The vibronic measuring device according to claim 1, wherein the electrical receiving signal S_{E} and/or the sensor signal (S_{S}) are supplied to the analysis unit in the time domain (S_{SZ}) and in the spectral domain (S_{SS}).

3. The vibronic measuring device according to claim 1, wherein a temperature signal (T) is supplied to the analysis unit as a further input signal.

4. The vibronic measuring device according to claim 1, wherein the analysis unit is detects periodic events.

5. The vibronic measuring device according to claim 1, wherein the analysis unit is detects frequency patterns.

6. The vibronic measuring device according to claim 1, wherein the analysis unit is generates and outputs a warning signal (W) when a quality of a desired signal that can be extracted from the electrical receiving signal (S_{E}) is too low.

7. The vibronic measuring device according to claim 1, wherein the analysis unit outputs a signal for adjusting at least one adaptive filter filtering the receiving signal (S_{E}) for delivery to the control and evaluation unit.

8. The vibronic measuring device according to claim 1, wherein the analysis unit detects and classifies events which cause extraneous vibrations and provides a classifier (K) to the control and evaluation unit.

9. The vibronic measuring device according to claim 1, wherein the control and evaluation unit adjusts a measuring rate and/or signal processing, particularly filtering, on the basis of a classification of an event.

10. A method for signal processing in a vibronic measuring device comprising
providing a mechanically oscillatory unit,
providing at least one drive and receiving unit for exciting the mechanically oscillatory unit to vibrate mechanically by means of an electrical excitation signal S_{A} and for receiving and converting mechanical vibrations into an electrical receiving signal (S_{E}), a control and evaluation unit for closed-loop control and/or open-loop control of the vibrational excitation and for evaluation of the receiving signal S_{E} with respect to the process variable, and
coupling at least one vibration sensor with the vibronic measuring device in such a manner that vibrations are transmitted from the measuring device to the vibration sensor to pick up a sensor signal (S_{S}) at the vibration sensor,
wherein the vibronic measuring device comprises an analysis unit connected to the control and evaluation unit, the method comprising
supplying the electrical receiving signal (S_{E}) and the sensor signal S_{S} to the analysis unit as input signals, and
transmitting at least one piece of reliability information (Z) for the electrical receiving signal (S_{E}) from the analysis unit to the control and evaluation unit, and
analyzing the input signals that are supplied to the analysis unit in a self-learning manner.

11. The method according to claim 10, wherein the electrical receiving signal S_{E} and/or the sensor signal (S_{S}) are supplied to the analysis unit in the time domain (S_{EZ}) and in the spectral domain (S_{ES}).

12. The method according to claim 10, wherein a temperature signal (T) is supplied to the analysis unit as a further input signal.

13. The method according to claim 10, wherein the analysis unit carries out a detection of periodic events.

14. The method according to claim 10, wherein the analysis unit carries out a detection of frequency patterns.

15. The method according to claim 10, wherein the analysis unit generates and outputs a warning signal (W) when a quality of a desired signal that can be extracted from the electrical receiving signal (S_{E}) is too low.

16. The method according to claim 10, wherein the analysis unit outputs a signal for adjusting at least one adaptive filter for the receiving signal (S_{E}) to the control and evaluation unit.

17. The method according to claim 10, wherein the analysis unit detects and classifies events which cause extraneous vibrations and outputs a piece of information about this, particularly a classifier.

18. The method according to claim 10, wherein the control and evaluation unit adjusts a measuring rate and/or signal processing, particularly filtering, on the basis of the classification and/or the type of an event.
